(19) United States
(12) Patent Application Publication
(10) Pub. No.: US 2009/0096752 A1
(43) Pub. Date: Apr. 16, 2009

(54) Hand tool with touch display

(76) Inventor: Chih-Ching Hsieh, Taichung City (TW)

Correspondence Address: Chien-Hui Su, P. O. Box 70-121 Taichung, Taichung City, 40899, TW

(21) Appl. No.: 11/388,623

(22) Filed: Mar. 23, 2006

(51) Int. Cl. G06F 3/041

(52) U.S. Cl. 345/173

(57) ABSTRACT

A hand tool with a touch display comprises a rod body having a control section; one end of the rod body being formed with a handle and another end thereof can be installed with a tool head for driving a screw means; a strain gauge installed in the rod body for measuring twisting force; a control section having a touch panel for receiving touch signals to set control values in the control section; wherein settings about twisting force can be set through the touch panel. The touch panel has a hand writing input function. The hand tool body has a pen rod attached thereon for inputting data to the touch panel. The touch panel is equipped with a back light illuminator or light emitting diodes.

### FIELD OF THE INVENTION

The present invention relates to handle tools, and in particular to a hand tool with a touch display, wherein the hand tool is installed with a touch panel so that the setting data can be inputted from the touch panel. Further a stain gauge is installed therein for measuring twisting forces.

### BACKGROUND OF THE INVENTION

Currently, strain gauges are installed to hand tools for measuring the twisting forces applied to driving objects so that the users can control the tightness of the driving objects not to destroy the objects. When twisting force is applied, the resistance of the strain gauge will change. The variation of the resistance is converted to calculate the twisting force. The values are displayed on a display as a reference to users. Thus the user can control the driving force. Some hand tools, such as those disclosed in U.S. Pat. No. 6,119,562, a control panel is installed in the handle tool. When the twisting force is over the setting value, the hand tool will trip to avoid an overlarge twisting force is applied to a driving object.

However above mentioned prior art, it is difficult to set the twisting value. Only a plurality of number keys and unit keys are installed on the hand tool. The area of a hand tool is small. It is only suitable for 2 to 4 buttons. Thus the setting work is difficult. More time is necessary. Even the setting work is difficult and thus it is often that the user deserts to use such functions.

### SUMMARY OF THE INVENTION

Accordingly, the primary object of the present invention is to provide a hand tool with a touch display, wherein the hand tool is installed with a touch panel so that the setting data can be inputted from the touch panel. Further a stain gauge is installed therein for measuring twisting forces.

To achieve above objects, the present invention provides a hand tool with a touch display which comprises a rod body having a control section; one end of the rod body being formed with a handle and another end thereof can be installed with a tool head for driving a screw means; a strain gauge installed in the rod body for measuring twisting force; a control section having a touch panel for receiving touch signals to set control values in the control section; wherein settings about twisting force can be set through the touch panel. The touch panel has the hand writing input function. The hand tool body has a pen rod attached thereon for inputting data to the touch panel. The touch panel has back light illuminator or is equipped with light emitting diodes.

The various objects and advantages of the present invention will be more readily understood from the following detailed description when read in conjunction with the appended drawing.

### BRIEF DESCRIPTION OF THE DRAWINGS

FIG. 1 is a perspective view of the hand tool with a touch display of the present invention.

FIG. 2 is a schematic view showing the use of the hand tool with a touch display of the present invention.

FIG. 3 is a perspective view of the second embodiment of the present invention.

FIG. 4 is a schematic view showing the second embodiment of the present invention.

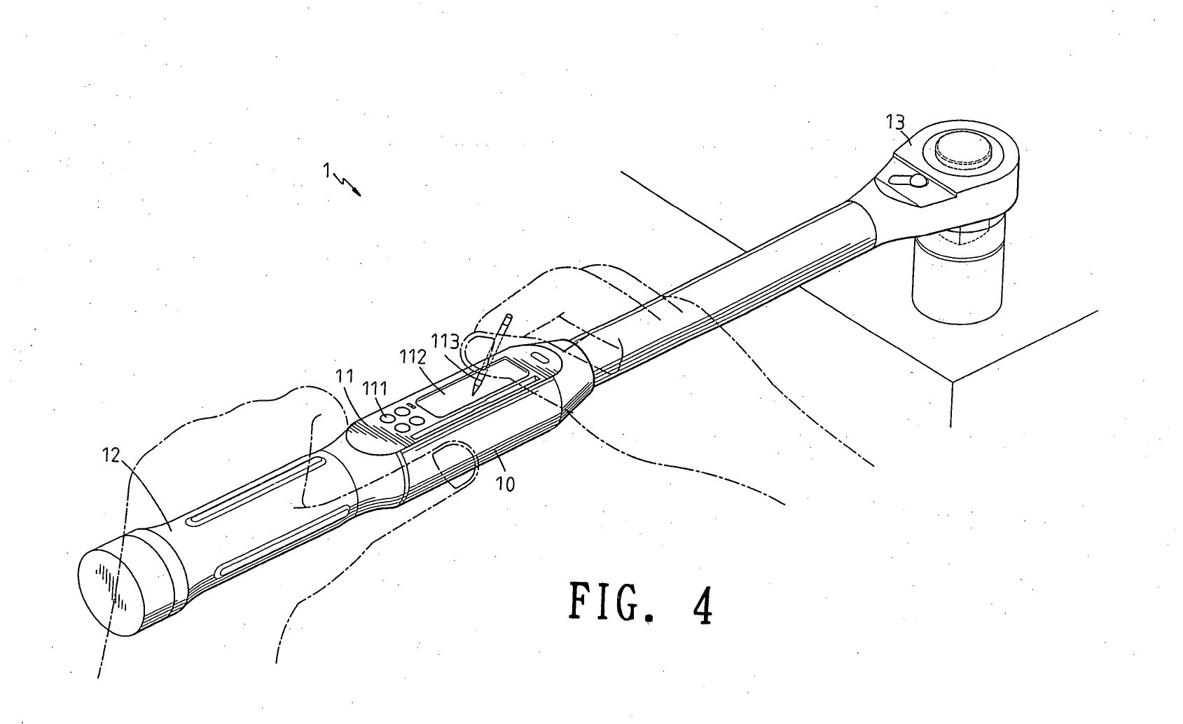

FIG. 5 is a schematic view showing one application of the present invention, wherein an illuminator is provided to the hand tool of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

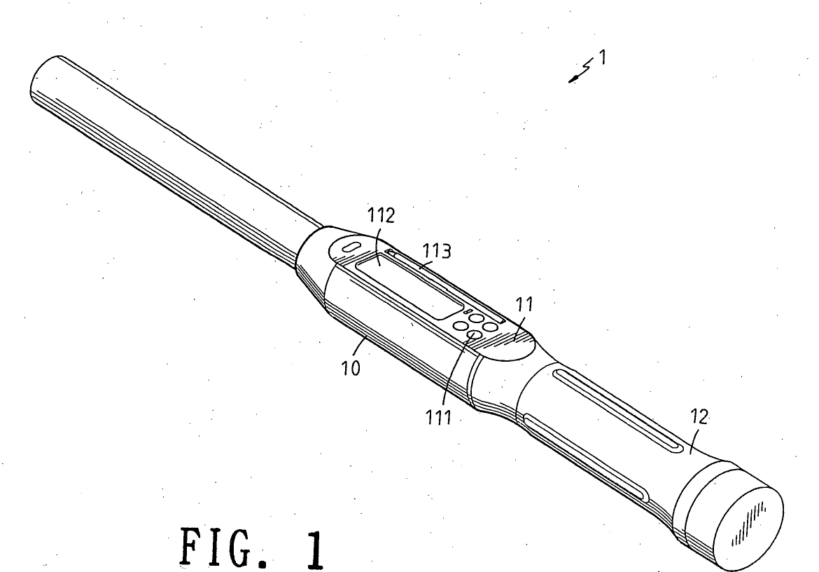

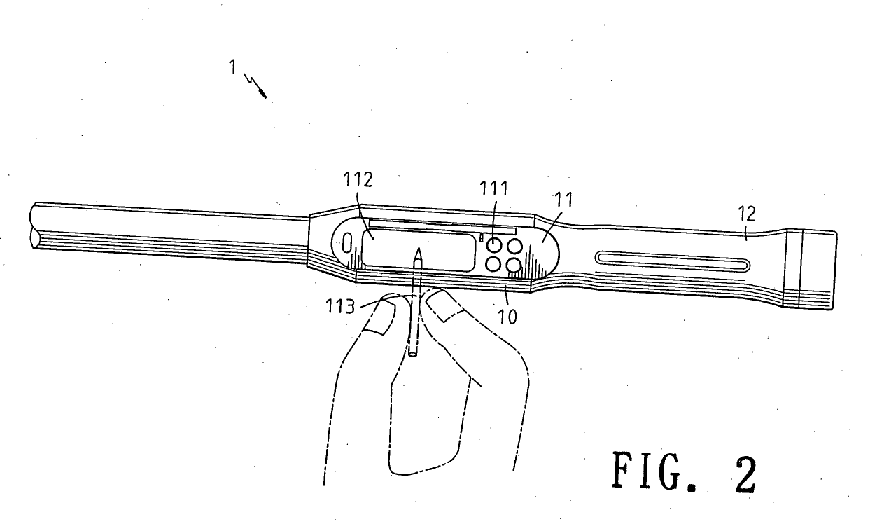

Referring to FIGS. 1 to 2, the hand tool with a touch display of the present invention is illustrated. The body 1 of the hand tool of present invention has the following elements.

A rod body 10 has a control section 11. One end of the rod body 10 is formed with a handle 12 and another end thereof can be installed with a tool head for driving a screw means.

The control section 11 includes a plurality of control buttons 111, a touch display 112 and pen rod 113 which is detachable. The control buttons 111 and touch display 112 serve to change the setting and display content of the control section 11. The touch display 112 has the functions of displaying information, data and receiving operation setting. The touch display 112 has formed by a liquid crystal display (LCD) and a touch panel for receiving touch signals. A scanner is installed between the liquid crystal display and the touch panel. In use, the scanner reads the image data of the LCD and the touch signals of the user from the touch panel are integrated so that the touch display 112 has the function of processing display data and receiving input data. User can input data through the touch display 112 by handwriting. Or as illustrated in FIG. 2, the pen rod 113 is taken down from the control section 11 for writing. The operation is simple, easy and convenient.

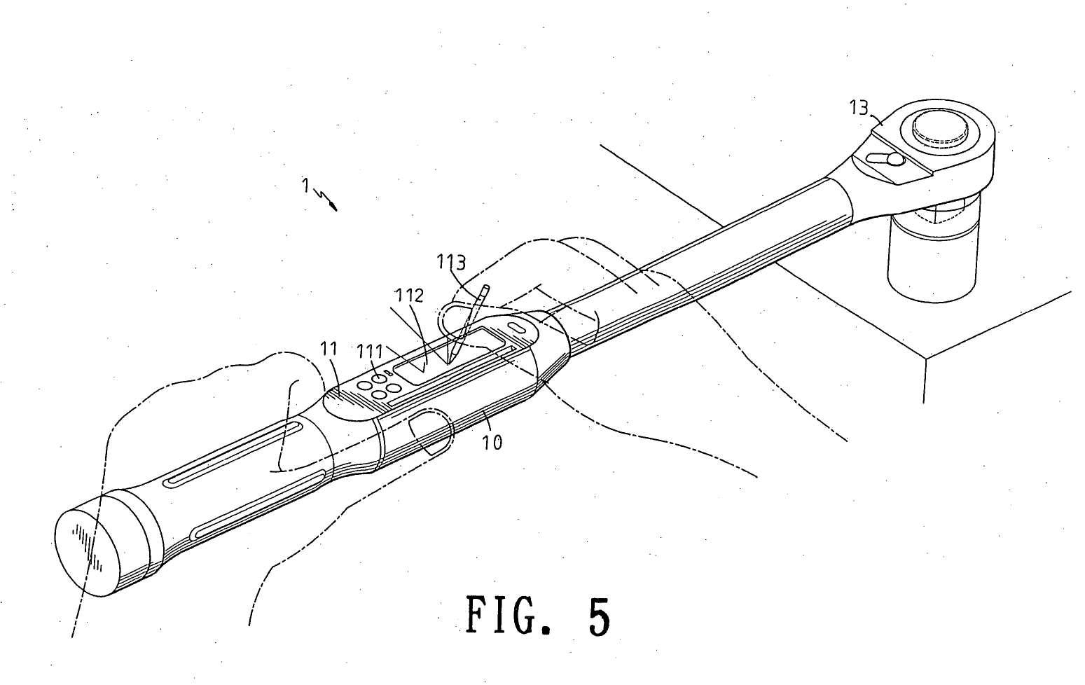

Moreover referring to FIG. 5, to have a personalized design, illuminators, such as a back panel, or light emitting diodes, can be added in the touch display 112. Thus, in dark area, the hand tool can still provide its function by the illuminators.

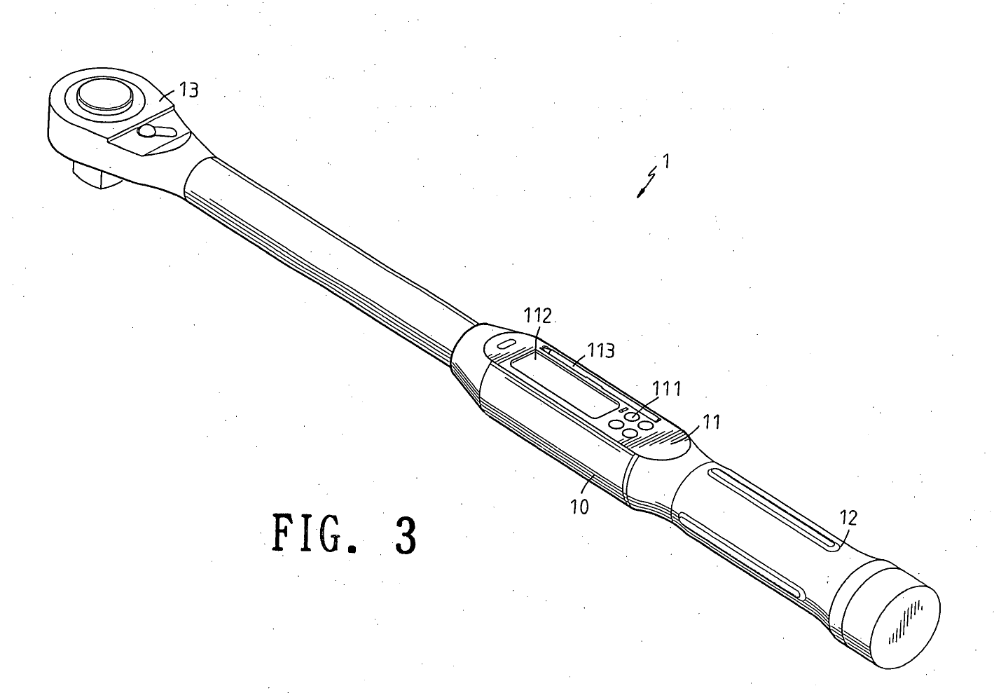

Referring to FIGS. 2 and 3, the second embodiment of the present invention is illustrated. Those identical to the first embodiment will not be described. Only those differences are described.

In this embodiment, the body 1 of the present invention is embodied as a spanner. One end of the rod body 10 of the body 1 is installed with a spanner head 13 so that the hand tool of the present invention is formed as a spanner. A strain gauge can be built in the body 1 so as to measure the twisting force applied. The upper limit of the twisting force can be set by setting on the touch display 112 or the control buttons 111 in the control section 11. If the twisting force applied is over the limiting value, a spanner can be released automatically or a buzz voice can be emitted (all those are known in the prior art and thus the details will not described herein). Thus, in the present invention, the setting of the control section 11 can be performed by setting the control buttons 111, or touching or hand-writing on the touch panel of the touch display. There are various ways being provided. Thus the operation is rapid, easily and convenient.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A hand tool with a touch display comprising:
a hand tool body;
a control section; and
a touch display on the control section; the touch display including a display and a touch panel for receiving touch signals as input data to setting control data of the hand tool body.

2. The hand tool with a touch display as claimed in claim 1, wherein the hand tool body is a spanner.

3. The hand tool with a touch display as claimed in claim 1, wherein a strain gauge is installed in the hand tool body.

4. The hand tool with a touch display as claimed in claim 1, wherein the touch panel has the hand writing input function.

5. The hand tool with a touch display as claimed in claim 1, wherein the hand tool body has a pen rod attached thereon for inputting data to the touch panel.

6. The hand tool with a touch display as claimed in claim 1, wherein the touch panel is equipped with a back light illuminator.

7. The hand tool with a touch display as claimed in claim 1, wherein the touch panel is equipped with light emitting diodes.

8. The hand tool with a touch display comprising:
a rod body having a control section; one end of the rod body being formed with a handle and another end thereof can be installed with a tool head for driving a screw means; a strain gauge is installed in the rod body for measuring twisting force;
a control section having a touch panel for receiving touch signals to set control values in the control section; wherein settings about twisting force can be set through the touch panel.

9. The hand tool with a touch display as claimed in claim 8, wherein the touch panel has the hand writing input function.

10. The hand tool with a touch display as claimed in claim 8, wherein the hand tool body has a pen rod attached thereon for inputting data to the touch panel.

11. The hand tool with a touch display as claimed in claim 8, wherein the touch panel has back light illuminator.

12. The hand tool with a touch display as claimed in claim 8, wherein the touch panel is equipped with light emitting diodes.
